(19) United States
(12) Patent Application Publication
(10) Pub. No.: US 2012/0055173 A1
(43) Pub. Date: Mar. 8, 2012

(54) EQUIPMENT AND METHOD FOR SURFACE TREATMENT BY JETS OF CRYOGENIC FLUID

(76) Inventors: Jacques Quintard, Presles (FR); Frédéric Richard, Parmain (FR); Charles Truchot, Poissy (FR)

(21) Appl. No.: 13/319,985

(22) PCT Filed: May 7, 2010
(86) PCT No.: PCT/FR10/50886

§ 371 Date: Nov. 10, 2011

(30) Foreign Application Priority Data
May 20, 2009 (FR) 0953359

(51) Int. Cl. F17C 7/02

(52) U.S. Cl. 62/52.1

(57) ABSTRACT

The invention relates to working equipment that uses one or more jets of high-pressure fluid at a cryogenic temperature, including a source (1) of cryogenic fluid connected to a mobile tool (4) including fluid-dispensing nozzles (11) for dispensing jets of high-pressure cryogenic fluid, and first and second protection enclosures arranged about the mobile tool (4) and connected to suction means (25). The plant further comprises gas sealing means (23) suitable for and designed to form at least one gas protection barrier between the two enclosures (20, 23) due to the supply of a dry gas into the second enclosure (23). The invention also relates to a method for implementing same and to the use thereof for the surface treatment, blasting, or peeling of a material using a high-pressure cryogenic fluid.

### CROSS REFERENCE TO RELATED APPLICATIONS

This application is a 371 of International PCT Application PCT/FR2010/050886, filed May 7, 2010, which claims priority to French Application No. 0953359, filed May 20, 2009, the entire contents of which are incorporated herein by reference.

### BACKGROUND

The invention relates to an installation and a method for blasting, peeling or surface treatment of coated or non-coated materials, such as metals, concrete, wood, polymers, plastics or any other type of material by jets of cryogenic fluid at very high pressure.

Currently, the surface treatment of coated or non-coated materials, in particular the blasting, peeling or the like of concrete, paint, etc., is mainly effected by sanding, by projection of water at ultra high pressure (UHP), with a sanding machine, with a pneumatic pick, with a bush hammer, or else by chemical means.

However, when water must not be present, for example in a nuclear or chemical product environment, for example because of drastic environmental restrictions, only so-called “dry” working methods can be used.

However, in certain cases these “dry” methods are difficult to use, are very laborious or arduous to use or even produce additional pollution, for example because of the addition of grit or sand, which then have to be reprocessed.

### SUMMARY

One alternative to these technologies is based on the use of cryogenic jets at very high pressure, as proposed in the documents U.S. Pat. No. 7,310,955 and U.S. Pat. No. 7,316,363. In this case, one or more jets of liquid nitrogen are used at a pressure of 1000 to 4000 bars and at a cryogenic temperature lying for example between −100 and −200° C., typically around −140 and −160° C., which are dispensed by a nozzle-bearing tool which is set in motion, typically rotational or oscillatory motion.

Now, the gaseous nitrogen dispensed by the nozzles, if it is released or liberated into the room where the surface treatment is taking place, creates anoxia risks for the operator, in particular if it accumulates there or if the room is ventilated badly or not at all.

For this reason, a suction hood is generally fitted around the surface treatment tool (or tools) from which the jet of liquid nitrogen emerges, said hood generally being equipped with a flexible edge strip, serving to provide mechanical barrier and contact functions between the suction hood and the surface to be treated. This edge strip can be provided with or formed of a row of flexible bristles, an elastic strip (rubber, leather, elastomer, etc.), or one or more foam material flanges, etc.

This suction hood makes it possible to create a partial seal between the tool and the surface to be treated and to extract all or part of the nitrogen delivered by the nozzles. This is particularly useful when it is desired to extract the waste matter produced during the surface treatment directly at the source in order to avoid it polluting the area wherein the surface treatment operation, for example surface blasting, is performed, particularly in the case of concrete peeling in radioactive environments.

The suction system employed must be at low pressure in order to avoid the release of nitrogen into the workroom/workplace and to be able to extract the residues from the surface effectively.

The nitrogen ejected by the nozzle-bearing tool, and the dust and waste such as pieces of concrete or the like, are extracted via the hood. To ensure maximum efficacy for the extraction, the extraction capacity must be greater than the flow rate of nitrogen at the tool. Thus, external air is also extracted.

However, the ambient air extracted contains moisture, in other words water vapor, which enters the extraction system.

Now, this extracted moisture generates two major problems.

Firstly, the moisture is adsorbed on the flexible edge strip, particularly on the bristles or the like, and then turns into ice on contact with the low temperatures of the hood. This can prove very obstructive to operations. In fact, the parts which make up the edge strip, such as the bristles, because of their flexibility, normally have to play a fundamental part as a contact zone between the suction hood and the surface to be treated. Now, if these parts set solid and become hard, contact between the hood and the substrate becomes very poor as it displays very little “sealing”. Poor quality extraction then follows, in other words rubble, dust or other waste will “pollute” the room where the treatment is taking place. This is unacceptable, particularly in industries where it is essential that the surface residues be extracted, such as the nuclear or chemical industries for example.

Moreover, the extracted moisture is transferred to the absolute filters with which an extraction system of this type is usually equipped. On these, this moisture agglomerates the dust and other surface residues to form a paste which clogs the absolute filters, which has a major impact on the efficacy of extraction and can render the latter inoperative. This results in frequent production stoppages to clean the absolute filters, which impairs the productivity.

Hence the problem to be solved is to propose an installation and a method for blasting, peeling and surface treatment of coated or non-coated materials, such as metals, concrete, wood, polymers, plastics or any other type of material, by a jet or jets of cryogenic fluid at very high pressure which are improved, in other words which do not, or at least much less frequently than with the previous method, lead to extraction defects due to poor sealing of the suction hood and/or clogging of filters or other purification or filtration devices with which the suction system is equipped.

The solution of the invention is a working installation which uses at least one jet of high-pressure fluid at cryogenic temperature comprising:

a source of fluid at cryogenic temperature, fluidly connected to a mobile tool containing one or more fluid dispensing nozzles for dispensing one or more jets of said fluid at cryogenic temperature under high pressure, and

a first protective enclosure fitted around the mobile tool and fluidly connected to suction means, said first protective enclosure comprising an open lower end situated at the side of the fluid dispensing nozzle or nozzles, in such a way as to form a suction hood around the tool.

The installation of the invention is characterized in that it further contains gaseous sealing means suitable for and designed to form at least one gaseous protection barrier at least at the lower end of the first protective enclosure and on at least a part of the periphery of said first protective enclosure, said gaseous sealing means comprising at least:

a second protective enclosure fitted around at least a part of the first protective enclosure and open at the lower end of the first protective enclosure, and

means for supplying dry gas fluidly connected to said second protective enclosure to supply the interior of said second protective enclosure with dry gas.

Depending on the situation, the installation of the invention can comprise one or more of the following characteristics:

the means of supplying dry gas comprise a source of dry nitrogen or dry air.

it contains at least one heat exchanger comprising an exhaust device, in particular a vent, fitted between the source of fluid at cryogenic temperature and the rotating tool, the means of supplying dry gas being fluidly connected to said exhaust device in such a way as to be able to recover at least part of the gas escaping through said exhaust device and to introduce it subsequently into said second protective enclosure.

the source of fluid at cryogenic temperature is a tank containing a cryogenic liquid topped with a gas headspace, the means of supplying dry gas being fluidly connected to said gas headspace via the source of fluid at cryogenic temperature.

the means of supplying dry gas conveying the dry gas to the protective enclosure comprise at least one gas supply line; the gas supply line is preferably equipped with a control and/or gas flow rate regulating device.

The invention also relates to a method for avoiding or minimizing contamination by atmospheric impurities of the interior of the first protective enclosure fitted around the mobile tool of a working installation that uses at least one jet of cryogenic fluid under high pressure dispensed by one or more nozzles fitted to a mobile tool, in particular a working installation according to the invention, said lower end of the first protective enclosure being positioned facing a surface to be treated, characterized in that a dry gas is fed in and at least one gaseous protection barrier is formed at least at the lower end of the first protective enclosure and on at least a part of the periphery of said first protective enclosure and in that the gaseous protection barrier is formed by means of least one second protective enclosure fitted around at least one part of the first protective enclosure and open at the lower end of the first protective enclosure, said second protective enclosure being fed with dry gas at a pressure higher than the pressure prevailing in the interior of the first protective enclosure and higher than the atmospheric pressure prevailing on the exterior of the second protective enclosure.

Depending on the situation, the method of the invention can comprise one or more of the following characteristics:

the dry gas is air or nitrogen, preferably nitrogen.

the dry gas is nitrogen deriving from the exhaust device of a heat exchanger in the installation and/or from the gas headspace of the source of the cryogenic fluid.

the cryogenic fluid dispensed by the nozzle or nozzles of the tool is at a pressure of at least 300 bar, preferably between 2000 and 5000 bar, and at a temperature lower than −140° C., preferably between about −140 and −180° C.

the atmospheric impurities are water vapor.

the flow rate of the dry gas feeding the interior of the second protective enclosure lies between 1 000 and 20 000 l/min, preferably between 5 000 and 15 000 l/min.

In addition the invention also relates to a method of surface treatment, blasting or peeling of a material by cryogenic fluid at high pressure, wherein an installation or a method as claimed in the invention is used.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a diagram of the operation of a working installation using cryogenic jets under very high pressure,

FIGS. 2a (side view) and 2b (bottom view) are diagrams of the nozzle-bearing tool fitted to the installation in FIG. 1,

FIG. 3 is a diagram of a standard extraction system fitted to the nozzle-bearing tool fitted to the installation in FIG. 1, and

FIG. 4 is a diagram of one embodiment of an extraction system according to the present invention fitted to the nozzle-bearing tool fitted to the installation in FIG. 1.

### DESCRIPTION OF PREFERRED EMBODIMENTS

FIG. 1 is a diagram of a standard installation for blasting, surface treatment or the like with jets of cryogenic liquid usually including a storage tank 1, such as a cistern, of liquid nitrogen (hereinafter referred to as LN₂) which feeds, via a supply line 6, liquid nitrogen under low pressure, in other words at about 3 to 6 bar and at a temperature of about −180° C., and a compression device 2 with upstream compressor and internal heat exchanger making it possible to bring the liquid nitrogen to ultra high pressure (UHP).

The compression device 2 thus makes it possible to effect the compression of the LN₂ coming from the storage tank 1.

The LN₂ at the first pressure (UHP) is then passed via a conveyor line (7) to an external downstream heat exchanger 3 where the LN₂ UHP undergoes cooling with liquid nitrogen at atmospheric pressure (in 9), typically to obtain UHP liquid nitrogen.

This results in LN₂ at a pressure (UHP) typically higher than 300 bar, generally lying between 2000 bar and 5000 bar, advantageously lying between about 3000 and 4000 bar, and at a temperature lower than −140° C., typically between −140° C. and −180° C., for example of the order of about −150 to −160° C., which is passed (in 8) to the tool 4 for blasting or the like dispensing one or more jets of UHP liquid nitrogen, in general several jets.

The large capacity tank 1, such as a truck cistern or a tank for storage of several thousands of liters of liquid nitrogen, is generally situated outside the buildings, in other words in the open air. It can be permanent or mobile.

The large capacity tank 1 is connected in a standard way to the installation, in other words by means of insulated pipework containing one or more control valves, etc. Further, the LN₂ is also conveyed between the various components of the system via insulated pipes. The overall gas flow rate is approximately 20 l/min i.e. 15 m³/min.

In general, the compression device 2, external exchanger 3 and especially the tool 4 are in principle situated in one or more buildings.

During the operation of the heat treatment method or the like, gaseous nitrogen at atmospheric pressure (about 1 bar) and at about −196° C. continually escapes from the two exchangers, namely the exchanger upstream of the compression device 2 and the downstream exchanger 3.

This nitrogen gas escape takes place via an exhaust device, such as a vent or the like, fitted on each of said heat exchangers 2 and 3.

In a prior art installation, this released nitrogen is not reused but is generally collected and expelled from the buildings to eliminate the risks of anoxia to personnel, in other words it constitutes a waste gas which is disposed of into the atmosphere.

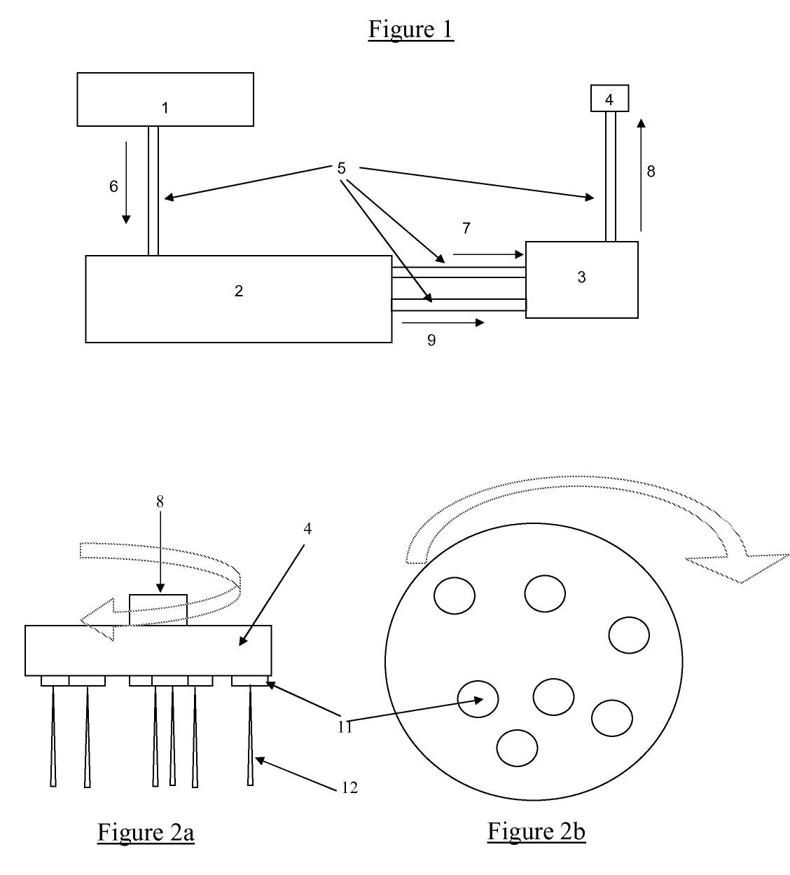

Furthermore, in order to increase the size of the area treated, in other words blasted or the like, a tool 4 equipped with nozzles 11 of the type used in the methods with jets of UHP water, is typically used, but here fed with UHP LN₂ (in 8), and which are rotated or oscillated in such a way as to obtain rotating or oscillating jets 12 of UHP LN₂ which are used to blast (or in an equivalent manner) the surface to be treated, as illustrated in FIG. 2a (side view) and FIG. 2b (bottom view).

In a manner in itself known, the nozzle-bearing tool 4 is usually rotated by a set of gear wheels, with or without a transmission belt, driven by an electric or pneumatic motor via a first rotating transmission shaft or axle connected to the motor, a transmission box or casing or enclosure containing a transmission mechanism using a set of internal gear wheels and a second transmission shaft or axle rotating here, itself connected to the mobile tool 4 equipped with nozzles.

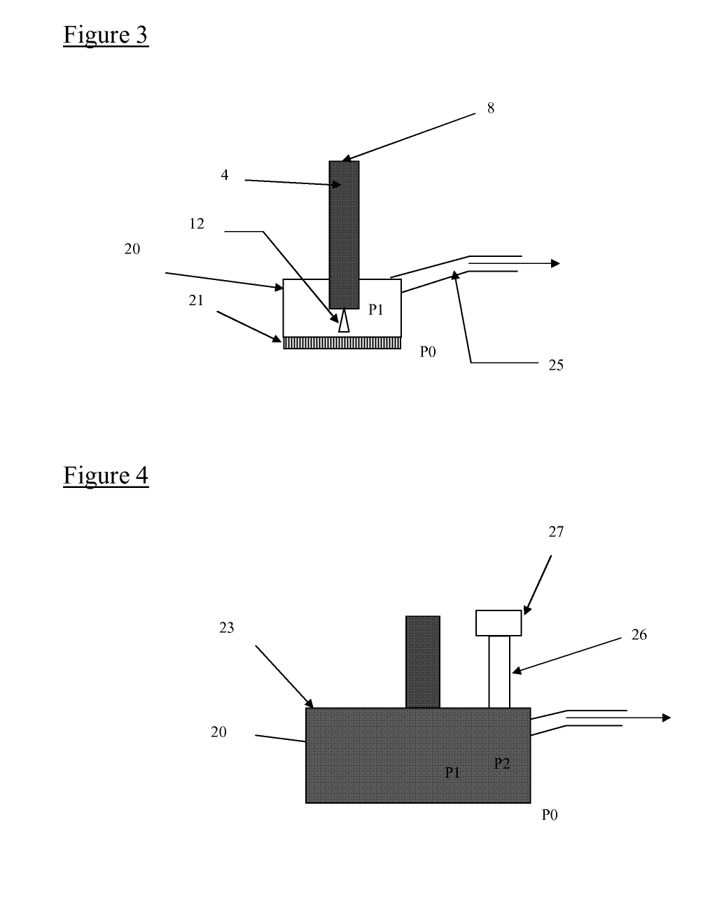

As illustrated in FIG. 3, in order to limit the risks to the operator of anoxia generated by the nitrogen gas supplied by the supply line 8 and then dispensed by the nozzles 11 which would be released and which would accumulate in the area where the surface treatment takes place, a first protective enclosure 20 forming a suction hood is generally fitted around the nozzle-bearing tool 4 which dispenses the jets 12 of liquid nitrogen. The hood 20 has an open lower end, which is positioned facing the surface to be treated and through which the jets 12 of cryogenic liquid under pressure dispensed by the nozzles 11 emerge.

This hood 20 is generally equipped, at its lower end which comes into contact with or is in immediate proximity to the surface to be blasted, with a flexible edge strip or skirt 21 which serves to ensure a mechanical and sealing barrier between the suction hood 20 and the surface to be treated. This edge strip or skirt 21 can be fitted with one (or several) rows of flexible bristles, an elastic strip (rubber, leather, elastomer, etc.), and with one or more foam material flanges, etc.

A standard low pressure extraction system 25, comprising a suction pump, one or more filters or other purification or filtration devices, is in fluidic communication with the interior of the suction hood 20 and makes it possible to extract the surface residues efficiently and also to avoid the release of nitrogen into the room where the surface treatment is performed.

In other words, the suction hood 20 constitutes a low pressure enclosure enveloping the tool 4, which makes it possible to recover and remove all or part of the nitrogen dispensed by the nozzles 11, as well as the dust generated by the method of blasting or the like. The pressure P1 prevailing in the hood 20 is preferably lower than the atmospheric pressure Po prevailing outside the hood 20, in other words in the room where the tool 4 is installed.

Now, ambient air, moisture and dust can be sucked in and gradually lead to poor sealing of suction hood 20 and/or to clogging of the filters or other purification or filtration devices with which the suction system 25 is equipped.

To remedy this, according to the present invention, a system of protection by a gaseous curtain or barrier comprising a second protective enclosure 23 covering the suction hood 21, in such a way as to form a double hood or double envelope around the tool 4 was incorporated into the installation in FIG. 3. This second protective enclosure 23 may or may not have an edge strip or a row of bristles, like the suction hood 20.

In order to obtain the desired gaseous curtain or barrier around the hood 20, a current of clean, dry gas at an overpressure (P2) over atmospheric pressure (Po) is introduced into the second protective enclosure 23 so as to create there an overpressure gaseous atmosphere constituting the desired gaseous barrier.

The second protective enclosure 23 thus serves as a mechanical barrier but above all serves for the creation of an insulating pneumatic barrier around the hood 20 intended to prevent the entry of atmospheric impurities, in particular water vapor (moisture) within the hood 20, which solves the aforesaid problems.

In fact, as the pressure P1 of dry gas in the suction hood 20 is lower than the pressure P2 in the second protective enclosure 23, the dry gas circulating from the second protective enclosure 23 towards the suction hood 20 is extracted by suction system 25 and at the same time, as the pressure P2 is higher than the external atmospheric pressure P0 (i.e., about 1 bar), there is no moist air in the double hood nor therefore a fortiori is there any in the extraction system 25. From there, all risk of ice formation on the bristles of the edge strip 21 of the suction hood 20 and moreover of clogging of the filters of the suction and filtration system 25 by moisture is eliminated.

The second protective enclosure 23 can cover all or part of the suction hood 21. Preferably it covers at least the lower part of the hood 20, in other words, the end of the hood 20 situated facing the surface to be treated and bearing the flexible protective edge strip or skirt in contact with the surface to be treated, since it is here that the harmful moist air can mainly penetrate.

The supply of the dry gas into the protective enclosure 23 is effected in the normal way via a gas supply line 26 for example, preferably equipped with a control and/or gas flow rate regulating device 27 which can comprise a valve, pressure reduction valve, flowmeter or other similar devices.

In the context of the present invention, a second protective enclosure 23 (or hood) is preferably used to form the protective gaseous curtain around the hood 20 but it goes without saying that any other equivalent system or device can be used as long as it makes it possible to obtain a gaseous barrier formed of a dry gas at overpressure relative to atmospheric pressure and to the pressure prevailing within the hood 20. In all cases, selection of the pressures P1 and P2 and fitting of the components of the system to obtain an efficient gaseous curtain is within the ability of those skilled in the art.

It should be emphasized that a third enclosure could also be fitted, or even a fourth enclosure or more, around the second enclosure and dry gas could likewise be dispensed there so as to create several consecutive gaseous barriers (i.e. gaseous curtains) and thus further improve the efficiency of the method and the device of the invention.

The pressurized dry gas used can be dry air from which all or almost all moisture has been removed, or else a dry neutral or inert gas, in particular dry nitrogen, which can be a waste gas from the method or else a gas packaged in gas bottles or any other type of gas storage container or tank, or else a gas conveyed through gas piping or a network of pipes.

In the context of the invention, “dry gas” refers to a gas or gaseous mixture containing less than 10% by volume of water vapor, in particular less than 5% by volume of water vapor and preferably free from water vapor.

The dry gas used can be compressed with a dedicated compressor whether or not equipped with filters or with any other means of gas purification, with a gas supply pipe or with a network of pipes.

However, it is preferable to use dry nitrogen forming the gas headspace in the cistern or tank 1, but even more preferably nitrogen constituting a waste gas or vent gas which is usually expelled into the atmosphere via the vents or the like with which the upstream 2 or downstream 3 heat exchangers of the installation in FIG. 1 are equipped.

In fact, during the operation of the heat treatment method, gaseous nitrogen at atmospheric pressure (about 1 bar) and about −196° C. continually escapes from the upstream exchanger and the downstream exchanger 3 of the compression device 2, this escape of gaseous nitrogen taking place via exhaust devices, such as vents or the like, fitted to said heat exchangers 2 and 3.

Recovery of this waste gas consisting of dry nitrogen is particularly advantageous as it makes it possible to use an available source of gas and add value to it rather than discharging it into the atmosphere. In other words, recycling of the nitrogen expelled through one or more of the vents on the heat exchangers of the installation into the interior of the second protective enclosure 23 is effected so as to create a gas overpressure there and obtain the desired pneumatic insulating barrier.

Preferably, the flow rate of the dry gas, in particular nitrogen, is greater than the difference in flow rate between the suction flow rate through the suction means and the flow rate of liquid then gaseous nitrogen ejected via the nozzles 11 for the surface treatment.

In order to check the efficacy of the solution of the present invention, an installation according to FIG. 1 was used in the standard manner, as illustrated in FIG. 3, and for comparative purposes with a second protective enclosure 23, as illustrated in FIG. 4 according to the invention.

In both cases, the flow rate of nitrogen gas, emerging liquid in the form of jets 12 dispensed by the nozzles 11 of the tool 4, is 300 m³/h, while the suction flow rate through the suction system 25 is 1 000 m³/h. The pressure P1 prevailing in the suction hood lies between 0.60 and 0.99 bar, preferably between 0.90 and 0.98 bar, and advantageously of the order of about 0.95 bar.

Without the double hood and without the arrival of dry gas, in other words with the standard device of FIG. 3, about 700 m³/h of air are extracted via the suction hood 20, that is about 350 m³/h gaseous humidity for air containing 50% humidity, which is equivalent to about 280 kg of liquid water per hour.

For comparative purposes, with the device according to the invention illustrated in FIG. 4, the addition of the second protective enclosure 23 around the suction hood 20 and the introduction into it of 700m³/h of dry gas, namely the waste nitrogen derived from the vents in the upstream and downstream heat exchangers, regulated by a flow rate control/regulating system makes it possible to reduce the quantity of water vapor (humidity) to almost zero since the outside air is no longer extracted owing to the pneumatic barrier created by the nitrogen curtain dispensed via the protective enclosure 23. Here, the pressure P1 prevailing within the suction hood is also in the region of 0.95 bar, while the pressure prevailing in the second protective enclosure 23 is greater than or equal to atmospheric pressure, typically in the region of about 1.05 bar.

The present invention is applicable in any treatment operation using jets of cryogenic fluid, in particular surface treatment, blasting or peeling of a material such as metals, concrete, stone, plastics, wood etc.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-13. (canceled)

14. A working installation using at least one jet of fluid at cryogenic temperature under high pressure comprising:
a source (1) of fluid at cryogenic temperature fluidly connected to a mobile tool (4) having one or more fluid dispensing nozzles (11) configured to dispense one or more jets of said fluid at cryogenic temperature under high pressure, and
a first protective enclosure (20) fitted around the mobile tool (4) and fluidly connected to suction device (25), said first protective enclosure (20) comprising an open lower end, situated at the side of the fluid dispensing nozzle or nozzles (11), so as to form a suction hood around the tool (4),
wherein the first protective enclosure (20) further contains a gaseous sealing element (23) suitable for and designed to form at least one protective gaseous barrier at least at the lower end of the first protective enclosure (20) and on at least a part of the periphery of said first protective enclosure (20), said gaseous sealing element (23) comprising:
a second protective enclosure (23) fitted around at least a part of the first protective enclosure (20) and open at the lower end of the first protective enclosure (20), and
a dry gas supply source (26, 27) fluidly connected to said second protective enclosure (23) and configured to supply the interior of said second protective enclosure (23) with a dry gas.

15. The installation of claim 14, wherein the dry gas supply source (28) comprises a source of dry nitrogen.

16. The installation of claim 14, wherein the dry gas supply source (28) comprises a source of dry air.

17. The installation of claim 14, further comprising at least one heat exchanger (2; 3), the heat exchanger comprising an exhaust device, in particular a vent, fitted between the source (1) of fluid at cryogenic temperature and the mobile tool (4), the dry gas supply source (26, 27) being fluidly connected to said exhaust device so as to be able to recover at least part of the gas escaping via said exhaust device and subsequently introduce it into said second protective enclosure (23).

18. The installation of claim 14, wherein the source (1) of fluid at cryogenic temperature is a tank containing a cryogenic liquid topped by a gas headspace, the dry gas supply source being fluidly connected to the gas headspace of the source (1) of fluid at cryogenic temperature.

19. The installation of claim 14, wherein the dry gas supply source is configured to convey the dry gas to the protective enclosure (23) and comprises at least one gas supply line (26).

20. The installation of claim 19, wherein the gas supply line (26) is equipped with a control device and/or gas flow control (27).

21. A method for avoiding or minimizing contamination by atmospheric impurities of the interior of a first protective enclosure (20) fitted around a mobile tool (4) of a working installation using at least one jet of high pressure fluid at cryogenic temperature dispensed by one or more nozzles (11) fitted to the mobile tool (4), a lower end of the first protective enclosure (20) being positioned facing a surface to be treated, the method comprising the step of: supplying a dry gas to form at least one gaseous protection barrier at least at the lower end of the first protective enclosure (20) and on at least a part of the periphery of said first protective enclosure (20), the gaseous protection barrier being formed by a second protective enclosure (23) fitted around at least a part of the first protective enclosure (20) and open at the lower end of the first protective enclosure (20), said second protective enclosure (23) being supplied with dry gas at a pressure (P2) greater than the pressure prevailing within the first protective enclosure (20) and greater than the atmospheric pressure prevailing outside the second protective enclosure (23).

22. The method of claim 21, wherein the dry gas is air or nitrogen.

23. The method of claim 21, wherein the dry gas is nitrogen deriving from an exhaust device of a heat exchanger of the installation and/or from a gas headspace of a source (1) of cryogenic fluid.

24. The method of claim 21, wherein the cryogenic fluid dispensed by the nozzle or nozzles of the mobile tool (4) is at a pressure of at least 300 bar, and at a temperature lower than −140° C.

25. The method of claim 21, wherein the atmospheric impurities are water vapor.

26. The method of claim 21, wherein the flow rate of the dry gas supplying the interior of the second protective enclosure (23) lies between 1,000 and 20,000 Liters/min.
